(19) United States
(12) Patent Application Publication
(10) Pub. No.: US 2002/0095325 A1
(43) Pub. Date: Jul. 18, 2002

(54) System and method for environmental health and safety management

(76) Inventor: Cynthia L. Chiles, Seligenstadt (DE)

Correspondence Address: LYON & LYON LLP, 633 WEST FIFTH STREET, SUITE 4700, LOS ANGELES, CA, 90071, US

(21) Appl. No.: 09/967,910

(22) Filed: Sep. 29, 2001

Related U.S. Application Data
(60) Provisional application No. 60/236,477, filed on Sep. 29, 2000.

(51) Int. Cl. G06F 17/60

(52) U.S. Cl. 705/9

(57) ABSTRACT

A method for providing EHS management solution includes the steps of receiving input regarding a solution to an EHS problem from a representative from different disciplines; iteratively communicating the inputs to the representatives; and integrating the inputs into a blueprint of the solution. Preferably, the blueprint is modified into an EHS commodity, stored in a repository, and resold over the Internet.

A system for generating a solution to an EHS management problem comprises a processor connected to a memory that stores prior EHS management problems; blueprints of solutions; EHS commodities; and a program for controlling the processor. The processor receives inputs from the representatives; iteratively communicates the inputs to and from the representatives; and integrates the inputs into a blueprint of the solution.

This application claims priority to U.S. Provisional Application Serial No. 60/236,477 entitled “System and Method for Performing Environmental Health and Safety Management,” filed on Sep. 29, 2000, and which is fully incorporated herein by reference.

### BACKGROUND OF THE INVENTION

1. Field of the Invention

The field of the present invention relates to the disciplines of law, environmental engineering and science, business management and accounting, and information technology as they relate to environmental health and safety management consulting. More particularly, the field of the present invention relates to systems and methods for consulting on and managing programs dealing with environmental health and safety issues.

2. Background Environmental, health and safety (EHS) management consulting (EHSMC) is a field in which guidance is provided to individuals, organizations, companies and other entities that must address environmental health and/or safety issues as a result of regulatory requirements, business and public relations concerns, or other priorities. EHSMC may include developing and instituting EHS management programs, orchestrating EHS training, EHS auditing and assessing, and/or EHS brokering.

EHSMC has roots in the core disciplines (i.e., fields of expertise) of law, environmental engineering and sciences, and business management and accounting. Consulting on EHS issues has traditionally taken place as a task peripheral to the performance of services in one or more of the core disciplines. However, as EHSMC issues have become more complex, the expertise needed in each of the core disciplines to resolve the issues has increased, making it difficult for a practitioner in any one discipline to manage the consulting efforts of other disciplines. Not the least of these difficulties is the potential liability associated with the management of EHS solutions that involve knowledge and know-how from multiple disciplines, as well as the regulations and restrictions in many jurisdictions regarding providing services of one or more disciplines under the umbrella of another discipline. Further, additional fields of expertise are becoming indispensable to EHS management problem solving and to EHS solution implementation. For example, information technology more and more is an integral component of many EHSMC programs and solutions. These issues have made the traditional EHSMC model generally ineffective at providing complete solutions to EHS problems as well as inefficient and unprofitable as a field of business.

While EHS management through one of the core disciplines is at best unprofitable, businesses that attempt to provide general EHSMC services face similar constraints. Such businesses have been unable to provide highest quality and cost-effective solutions to EHS issues and problems while still being financially profitable as service providers. The existence of and necessity for high levels of expertise in numerous disciplines has made it difficult, if not impossible, for the traditional EHS management consulting organization to provide quality service at a reasonable cost.

### SUMMARY OF THE INVENTION

The present invention is directed to systems and methods for providing environmental health and safety (EHS) management solutions to clients, e.g., manufacturers, refiners, wholesalers, etc., and in a further aspect, for leveraging the solutions to other clients and for crafting new solutions. Another aspect of the invention is the delivery of EHS management solutions through an electronic commerce web site that enables solutions to be resold at a price that is less than the traditional consulting market place.

In one embodiment according to the present invention, an EHS management system is comprised of a central controller, client interface, a plurality of representative interfaces, and consultant interface. A client transmits an EHS management problem via the client interface into the central controller. The central controller then identifies client information, industry information, and services and/or product information from the EHS management problem, and in turn extracts pertinent EHS management data from the memory. Preferably, the memory maintains databases that store EHS management data associated with the client, its industry type(s), EHS services or products requested by the client, and representatives from a plurality of different disciplines necessary to solve the EHS management problem. In addition, the memory preferably maintains a database for prior EHS management problems and blueprints of their solutions. Next, the EHS management problem and the pertinent EHS management data are transmitted to the representative interfaces and to the consultant interface. Each representative then utilizes the pertinent EHS management data and its expertise to generate input on the potential solution for the EHS management problem. The inputs are then transmitted back to the central controller and to the consultant interface. The consultant then organizes and assesses the inputs and coordinates the generation of an initial blueprint of a solution. Preferably, the initial blueprint is presented to each representative to invite additional input, and the inputs are integrated into the blueprint. At the discretion of the consultant, an iterative process of gathering input from the representatives and integrating that input into the blueprint for the solution is continued. Finally, the blueprint for the solution is transmitted to the client interface.

According to one aspect of the present invention, the blueprint for the solution is modified into an EHS commodity for resale and stored in the memory. In another aspect of the present invention, access to the memory is made available to potential EHS commodities buyer via the Internet. In such a case, the central controller acts as a server having a commercial web site. The above and other objects, features, and advantages will become apparent to those skilled in the art from the following description of the preferred embodiments.

### BRIEF DESCRIPTION OF THE DRAWINGS

FIG. 1 is a diagram depicting a system configuration of the present invention.

FIG. 2 is a block diagram showing an embodiment of the central controller.

FIG. 3 is a flow diagram depicting a method for generating a blueprint of a solution to an EHS management problem according to the present invention.

### DETAILED DESCRIPTION OF THE PREFERRED EMBODIMENTS

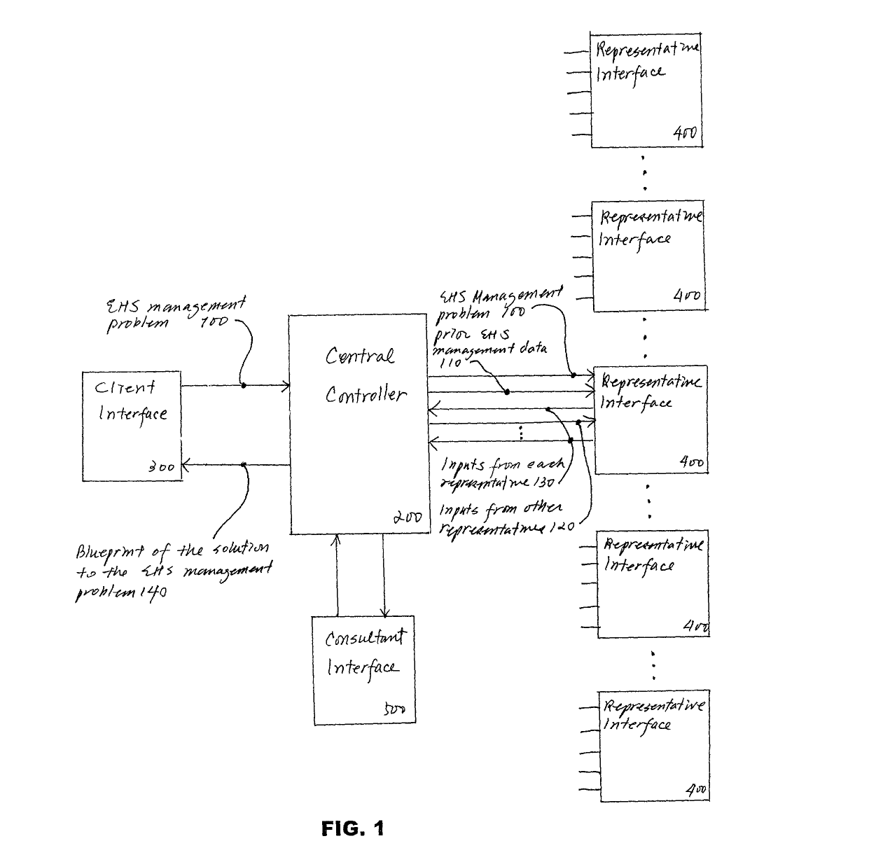

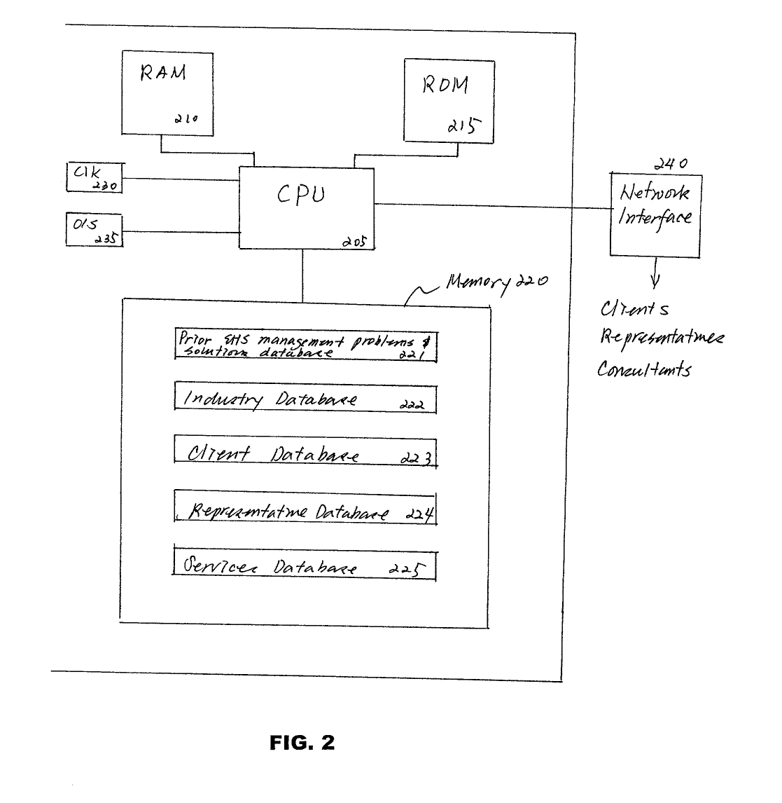

FIGS. 1 and 2 illustrate a system configuration of an embodiment of a system for providing EHS management solutions. As shown in the FIG. 1, the embodiment preferably comprises a central controller 200, client interface 300, a plurality of representative interfaces 400, and consultant interface 500. Each interface is connected by a communication link, for example, the Internet. Other communication links can be utilized, including, and not limited to, dedicated data lines, mobile phone systems, microwave, infrared, or satellite networks. Each of the client interface 300, representative interface 400, and consultant interface 500 preferably includes terminals that serve as output and input gateways for communications with the central controller 200.

As shown in FIG. 2, the central controller 200 preferably includes a central processor 205, RAM 210, ROM 215, clock 230, memory 220, and operating system 235. The central controller 200 communicates with clients, representatives and the EHS management consultant via the network interface 240. The memory 220 comprises a plurality of databases, preferably including a prior EHS management problem and solution database 221 (hereinafter prior EHS database), industry database 222, client database 223, representative database 224, and service database 225.

The central controller 200 may comprise a computer (like those manufactured by IBM® or Apple®) with a monitor, such as a cathode ray tube (CRT) or liquid crystal display (LCD). Computer software, or programs, may be used for the central controller 200 because software provides flexibility in programming and modifying the software, displaying results, and running other peripheral applications. Alternatively, the central controller 200 may be implemented using any type of processor or processors that provide EHS management solutions as described herein. Thus, as used throughout, the term “processor” refers to a wide variety of computational devices or means including, for example, using multiple processors that perform different processing tasks or having the same tasks distributed between processors. The processor(s) may be general purpose CPUs or special purpose processors, such as those often used in digital signal processing systems. Further, multiple processors may be implemented in a server-client or other network configuration or as a pipeline array of processors. Some or all of the processing may be alternatively implemented with hard-wired circuitry such as an ASIC, FPGA or other logic device. In conjunction with the term “processor,” the terms “memory” and “database” refer to any storage medium that is accessible to a processor that meets the memory storage needs for the EHS management system or its components.

The prior EHS database 221 stores prior EHS management problems and their corresponding blueprints of solutions to the problems. In one embodiment, the prior EHS database 221 also stores sub-issues comprising the EHS management problem and the corresponding sub-solutions. In another embodiment, the prior blueprints of solutions and sub-solutions to EHS management problems are stored in a generic form that can be resold as EHS commodities.

The industry database 222 stores various EHS management data according to different industry types such as aerospace, chemicals, consumer products, electronics, food products, general manufacturing, government, oil and gas, paint and coatings, pharmaceutical, plastics, pulp and paper, transportation, utility, and waste management. Preferably, the EHS management data in this database preferably includes prior EHS management problems and solutions uniquely associated with each industry type, strategic partners or representatives information who are experts for each industry type, and prior client information in each industry type. Appropriate set of EHS data stored in the industry database 222 are readily made available to the central processor 205.

The client database 223 stores data regarding clients, for example, client name, industry type, past EHS performance and practices, prior EHS management problems and solutions, and strategic partners or representatives from a variety of disciplines who have expertise in dealing with the client's EHS management problems. Like the industry database 222, the client database 223 makes appropriate set of EHS data readily available to the central processor 205.

The representative database 224 stores EHS management data regarding strategic partners or representatives from different disciplines, preferably from law, business management, environmental engineering, science and information technology. The EHS management data stored in this database preferably includes representative specific information, for example, what industry types, clients, and prior EHS management problems and solutions in which each representative has experience. Also, discipline specific information, i.e., what management problems and solutions must be addressed by each discipline, are preferably included.

The services database 225 stores EHS management data associated with different EHS services or product requested by clients, for example, auditing, establishing business strategy, environmental due diligence assessment, green product strategy and technical assessment, and software development for EHS management. Preferably, prior EHS management problems and solutions associated with each service or product are stored in the services database 225. Moreover, data on representatives and other clients pertinent to each service or product are stored.

The network interface 240 serves as a gateway to communicate with clients, representatives and EHS consultants via their respected interfaces. In one embodiment, the network interface 240 is connected to the Internet. In such a case, the network interface 240 can be materialized as a world-wide-web site, BBS, or electronic mail address. Entities having access to the Internet may then easily and quickly exchange EHS data in the form of document files, graphics, audio, video or other form of information.

In one embodiment as described herein, a business model is provided for effecting a method of profitably creating blueprints of solutions to EHS management problems and issues, and realizing the solutions from the blueprints. In the business model, a management consulting organization comprising a strategic partnership of at least four areas of specialization (e.g., law, business management, environmental engineering, science, and information technology) is formed into a multidisciplinary solution-identifying think tank. The think tank is directed to solving EHS problems and issue, although in other embodiments the multidisciplinary think tank is directed to other kinds of consulting. Preferably, the strategic partners are partial owners and/or are otherwise formally contracted with the consulting organization. Also, the organization preferably assumes all responsibility and liability for the EHSMC services that it provides its clients. Preferably, each strategic partner has name recognition within its respective industry, yet is not necessarily a market leader in the industry. For example, in the field of law, the strategic partner may be a respected mid-sized law firm with experience in handling EHS legal issues.

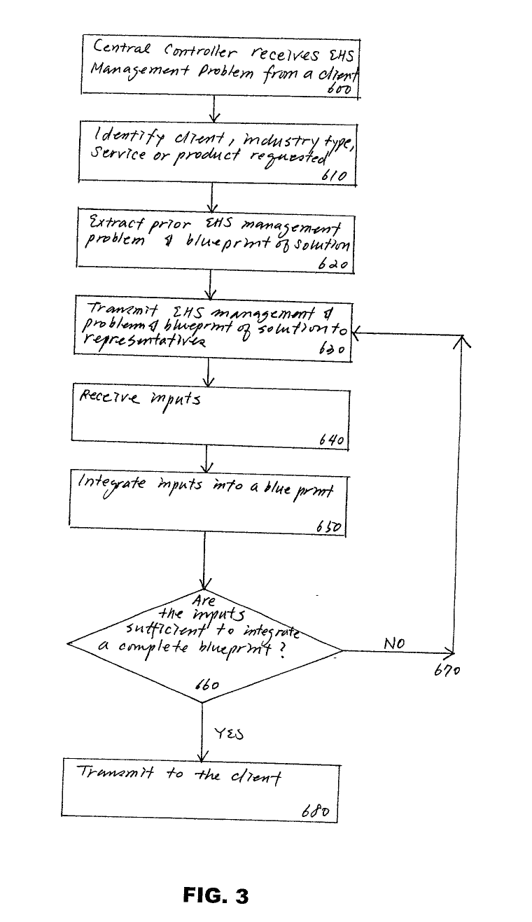

FIG. 3 is a process flow diagram depicting a preferred method that is initiated when a client presents an EHS problem to the EHSMC organization 600. Preferably, this communication takes place via the Internet, with the central controller 200 acting as a web server. The client and the organization preferably agree to a price for a blueprint of a solution to the EHS problem and that the blueprint for the solution, preferably in its generic form, is owned by the organization and may be resold by the organization as a commodity to other clients. In one embodiment, the central controller 200, preferably acting as a server, posts the commodity or its simple description on an electronic commerce web site. This allows potential EHS commodities buyers to shop using popular web browsers such as the Microsoft Internet Explorer® or Netscape Navigator®. Moreover, other entities interested in selling their own EHS commodities may request the organization to post their EHS commodities or information thereof on the web site. Preferably, the organization can charge other entities in return for this service.

In crafting the blueprint for a solution to an EHS issue or problem, each specialization (i.e., strategic partner/representative) within the organization is presented with a description of the issue or problem at the outset of the solution-crafting process. In one embodiment, this is accomplished by first programming the central controller 200 to identify from the initial communication the identity of the client, its industry type, and service or product requested 610. Then, the central controller 200 extracts prior EHS management problems and blueprints of solutions associated with the client, its industry type, and services or products it has requested 620 from the memory 220. Next, the central controller 200 transmits the EHS problem along with prior EHS management information to the representatives from different disciplines 630 via the network interface 240.

Consequently, input on the potential solution from each specialization is preferably provided early in the solution-crafting process. Input from each strategic partner is organized and assessed by a preferably centralized solution-coordinating EHS management consultant 640. The consultant then coordinates the generation of an initial blueprint of a solution based on the initial input provided by each strategic partner 650. The blueprint may be in the form of a product, a strategy, a program, a technology, or a combination of such elements. In a preferred implementation, the initial blueprint is presented to each strategic partner to invite additional input 670. This additional input is then integrated into the blueprint 650. Accordingly, an iterative process of gathering input from the strategic partners and integrating that input into the blueprint for the solution continues at the discretion of the EHS management consultant 660.

Next, a budget is developed, preferably including cost for implementing the blueprint and a market value assessment for the eventual resale of the blueprint (commodity) in the electronic commerce web site. The strategic partners preferably provide input on the budget and market value assessment. The blueprint for the solution and the budget to implement the blueprint are then sold to the client 690.

The EHSMC organization, by developing blueprints to various EHS problems preferably builds a repository of such blueprints. The repository may then be accessed by the EHS management consultant or other strategic partner when attempting to identify whether solutions to new problems have already been developed, or whether an existing solution may be modified to solve a new problem. In one embodiment as illustrated in FIGS. 1 and 2, the repository is materialized as a memory 220, and a central processor 205 of a central controller 200 acting as a server enables potential buyers, consultants, and/or representatives to have access to the repository through the network interface 240. As described above, the network interface 240 can take on many forms, e.g., the world-wide-web, electronic mail, telephone, fax or postal mail transmissions.

In a preferred embodiment, EHS problems and solutions are, to the extent possible, broken down or categorized into discrete sub-problems and sub-solutions. For example, as described in FIG. 2 and above, EHS problems and solutions may be broken down or categorized into sub-issues and sub-solutions according to client identity 223, industry type 224, representative 224, and services or product requested 225. In such a form, the data in the repository enables the EHS management consultant and strategic partner to develop new solutions to new EHS problems by piecing together the sub-solutions stored by the repository.

As blueprints for different EHS solutions are developed, the value of each new blueprint as a proprietary solution to an EHS management problem may then be assessed for resale in an electronic commerce web site or electronic marketplace. Based on that assessment, the proprietary blueprint of the solution may then be resold to other interested parties at a price that is preferably below the original development cost. The electronic market place reverses the typical business strategy of selling EHS management services: from a high cost, high price one-time sale to a client; to a low margin, high quantity resale of an EHS commodity. The method affords small and medium businesses as well as government and non-government entities greater access to EHS management consulting solutions that are otherwise typically unaffordable.

In another preferred embodiment, the organization makes available additional sales strategies that provide greater access to and affordability of EHS management solutions. These strategies include first, for a one-time fee, entitling the client to access and utilize the electronic commerce web site or repository of EHS management commodities for a fixed period (e.g., one year). This provides the client an entire inventory of EHS management solutions that they own, thereby eliminating development costs of these solutions for their company. Second, for an annual subscription fee the client is entitled to purchase any EHS management commodity at a discounted (from the public) price. In one embodiment, following the development of a blueprint for solving an EHS management problem, the blueprint is held in the repository for a period of time (e.g., three years) before it becomes available as a commodity for resale, so that the client who originally contracts for the development of the blueprint can have the market advantage that the implementation of the blueprint might provide. As an incentive for clients to opt to take the more costly process of developing an EHS management blueprint with the organization and its strategic partners, the EHSMC organization provides the client financing alternatives. One embodiment, the revenues generated by the sale of the blueprints may be shared between the EHSMC organization and the client.

The client may opt to purchase the blueprint for the solution from the organization and then seek an implementation of the blueprint elsewhere, or the client may request that the organization effect the implementation of the solution. Based on the previously identified budget, the organization then preferably proceeds along a second phase of the EHSMC service in which the client's EHS management problem is handled according to the previously derived blueprint. The solution preferably is then instantiated by the strategic partners that derived the original blueprint for the solution.

Although the invention has been described with reference to preferred embodiments, it will be readily appreciated by those of ordinary skill in the art that many modifications and adaptations of the invention are possible without departure from the spirit and scope of the invention.

What is claimed is:

1. A method of generating a solution to an EHS management problem comprising the steps of:
receiving an EHS management problem from a client;
communicating the EHS management problem to a representative in each of a plurality of different disciplines;
receiving input regarding a solution to the EHS problem from the representative in each of the plurality of different disciplines;
iteratively communicating the inputs from each of the plurality of different disciplines to the representative in each of the plurality of different disciplines;
iteratively integrating the input into a blueprint of the solution; and providing the blueprint of the solution to the client in return for a fee.

2. The method of claim 1 further comprising the steps of:
modifying the blueprint of the solution to the EHS problem into a resalable EHS commodity;
storing the EHS commodity and/or information thereof into a repository; and
reselling the EHS commodity.

3. The method of claim 2 wherein the EHS commodity is resold after a predetermined period.

4. The method of claim 2 further comprising the step of returning to the client a predetermined portion of revenue from reselling the EHS commodity.

5. The method of claim 2 wherein the EHS commodity is resold after a predetermined period and a predetermined portion of revenue thereof is returned to the client.

6. The method of claim 2 wherein the EHS commodity and/or information thereof is electronically stored.

7. The method of claim 6 wherein the commodity is resold after a predetermined period.

8. The method of claim 6 further comprising the step of returning to the client a predetermined portion of revenue from reselling the EHS commodity.

9. The method of claim 6 wherein the EHS commodity is resold after a predetermined period and a predetermined portion of revenue thereof is returned to the client.

10. The method of claim 1 further comprising the steps of:
modifying the blueprint of the solution to the EHS problem into a resalable EHS commodity;
receiving a plurality of EHS commodities and/or information thereof from a plurality of potential EHS commodities sellers;
electronically storing the EHS commodities and/or information thereof into a repository;
electronically posting on the Internet for resale the EHS commodities and/or information thereof stored in the repository;
receiving purchase orders from an EHS commodities buyer; and
reselling the EHS commodities to the EHS commodities buyer for a fee pursuant to a predetermined fee arrangement.

11. The method in claim 10 wherein the EHS commodities and/or information thereof are electronically posted on the Internet in return for a fee.

12. The method in claim 10 further comprising the step of sharing the fee from reselling the EHS commodities with the potential EHS commodities sellers.

13. The method in claim 10 wherein the predetermined fee arrangement includes a one-time fee arrangement that entitles the EHS commodities client to access and utilize the repository for a predetermined fixed period of time.

14. The method in claim 10 wherein the EHS commodities and/or information thereof are electronically posted on the Internet in return for a fee and wherein the fee from reselling an EHS commodity is shared with the client providing the EHS commodity resold.

15. A method of generating a solution to an EHS management problem comprising the steps of:
electronically storing a plurality of blueprints of prior solutions to prior EHS problems in a repository;
receiving from a client an EHS problem for which a solution is to be devised;
identifying a plurality of sub-issues comprising the EHS problem;
identifying from the repository a blueprint of a sub-solution to at least one of the plurality of sub-issues;
integrating the blueprint of the sub-solution to at least one of the plurality of sub-issues into a blueprint of a solution; and
providing the blueprint of a solution to the client in return for a fee.

16. The method of claim 15 wherein the plurality of blueprints of prior solutions to prior EHS problems include blueprints from clients interested in reselling their blueprints of solutions to EHS problems.

17. The method of claim 15 further comprising the step of electronically storing the blueprint of the solution to the EHS problem in the repository.

18. A method of generating a solution to an EHS management problem comprising the steps of:
electronically storing a plurality of blueprints of prior solutions to prior EHS problems in a repository;
receiving an EHS management problem from a client;
identifying a plurality of sub-issues comprising the EHS problem;
identifying from the repository a blueprint of a sub-solution to at least one of the plurality of sub-issues;
communicating the EHS management problem, the sub-issues comprising the EHS problem, and the blueprint of the sub-solution to a representative in each of a plurality of different disciplines;
receiving input regarding a solution to the EHS problem from the representative in each of the plurality of different disciplines;
iteratively communicating the inputs from each of the plurality of different disciplines to the representative in each of the plurality of different disciplines;
iteratively integrating the input and the blueprint of the sub-solution to at least one of the plurality of sub-issues into a blueprint of the solution; and
providing the blueprint of the solution to the client in return for a fee.

19. The method in claim 18 further comprising the steps of:
modifying the blueprint of the solution to the EHS problem into a resalable EHS commodity;
storing the EHS commodity and/or information thereof into the repository; and
reselling the EHS commodity for a fee to an EHS commodities buyer pursuant to a predetermined fee arrangement.

20. The method of claim 19 wherein the EHS commodity is resold after a predetermined period.

21. The method of claim 19 further comprising the step of returning to the client a predetermined portion of revenue from reselling the EHS commodity.

22.The method of claim 19 wherein the EHS commodity is resold after a predetermined period and a predetermined portion of revenue thereof is returned to the client.

23. The method in claim 19 wherein the predetermined fee arrangement includes a one-time fee arrangement that entitles the EHS commodities buyer to access and utilize the repository for a predetermined fixed period of time.

24. A system for generating a solution to an EHS management problem comprising:
a memory; and
a processor connected to the memory,
the memory storing a plurality of prior EHS management problems;
blueprints of solutions to the plurality of prior EHS problems; and
a program for controlling the processor; and
the processor operative with the program to:
receive the EHS management problem from a client;
transmit the EHS management problem to the memory for storage;
transmit the EHS management problem to a representative in a plurality of disciplines;
receive input regarding a solution to the EHS problem from the representative in each of the plurality of different disciplines;
iteratively communicate the input to and from the representative in each of the plurality of different disciplines;
iteratively integrate the input into a blueprint of the solution;
transmit the blueprint of the solution to the memory for storage; and
transmit the blueprint of the solution to the client.

25. The system of claim 24 wherein the processor is further operative with the program to:
modify the blueprint of the solution to the EHS management problem into a resalable EHS commodity;
transmit the EHS commodity and/or information thereof to the memory for storage;
make the EHS commodity and/or information thereof available to a plurality of potential EHS commodity buyers;
receive at least one purchase order from the plurality of potential EHS commodity buyers; and
transmit the EHS commodity to the plurality of potential EHS commodity buyers pursuant to a purchase agreement.

26. The system of claim 25 wherein the processor is further operative with the program to make the EHS commodity and/or information thereof available to a plurality of potential EHS commodity buyers via the Internet.

27. The system of claim 24 wherein the processor is further operative with the program to:
modify the blueprint of the solution to the EHS management problem into a resalable EHS commodity;
receive a plurality of EHS commodities and/or information thereof from a plurality of potential EHS commodity sellers;
transmit the EHS commodities and/or information thereof to the memory for storage;
make the EHS commodities and/or information thereof available to a plurality of potential EHS commodity buyers;
receive at least one purchase order from the plurality of potential EHS commodity buyers; and
transmit the EHS commodity to the plurality of potential EHS commodity buyers pursuant to a purchase agreement.

28. The system of claim 27 wherein the processor is further operative with the program to make the EHS commodity and/or information thereof available to a plurality of potential EHS commodity buyers via the Internet.

29. A system for providing a solution to an EHS management problem comprising:
a memory; and
a processor connected to the memory,
the memory storing a plurality of prior EHS management problems;
blueprints of solutions to the plurality of prior EHS problems; and
a program for controlling the processor; and
the processor operative with the program to:
receive the EHS management problem from a client;
transmit the EHS management problem to the memory;
identify a plurality of sub-issues comprising the EHS management problem based upon a comparison of the EHS management problem to the plurality of prior EHS problems stored in the memory;
identify from the memory a blueprint of a sub-solution to at least one of the plurality of sub-issues;
integrate the blueprint of the sub-solution to at least one of the plurality of sub-issues into a blueprint of a solution; and
transmit the blueprint of solution for the EHS management problem to the client.

30. The system of claim 29 wherein the processor is further operative with the program to:
modify the blueprint of the solution to the EHS management problem into a resalable EHS commodity;
transmit the EHS commodity and/or information thereof to the memory for storage;
make the EHS commodity and/or information thereof available to a plurality of potential EHS commodity buyers;
receive at least one purchase order from the plurality of potential EHS commodity buyers; and
transmit the EHS commodity to the plurality of potential EHS commodity buyers pursuant to a purchase agreement.

31. The system of claim 30 wherein the processor is further operative with the program to:
receive a plurality of EHS commodities and/or information thereof from a plurality of potential EHS commodity sellers; and
transmit the plurality of EHS commodities and/or information thereof to the memory for storage.

32. The system of claim 30 wherein the processor is further operative with the program to make the EHS commodity and/or information thereof available to a plurality of potential EHS commodity buyers via the Internet.

33. The system of claim 31 wherein the processor is further operative with the program to make the EHS commodity and/or information thereof available to a plurality of potential EHS commodity buyers via the Internet.

34. A system for generating a solution to an EHS management problem comprising:
a memory; and
a processor connected to the memory,
the memory storing a plurality of prior EHS management problems;
blueprints of solutions to the plurality of prior EHS problems; and
a program for controlling the processor; and
the processor operative with the program to: receive the EHS management problem from a client;
transmit the EHS management problem to the memory for storage;
identify a plurality of sub-issues comprising the EHS management problem based upon a comparison of the EHS management problem to the plurality of prior EHS problems stored in the memory;
identify from the memory a blueprint of a sub-solution to at least one of the plurality of sub-issues;
transmit the EHS management problem, the plurality of sub-issues comprising the EHS management problem, and the blueprint of the sub-solution to at least one of the plurality of sub-issues to a representative in a plurality of disciplines;
receive input regarding a solution to the EHS problem from the representative in each of the plurality of different disciplines;
iteratively communicate the input to and from the representative in each of the plurality of different disciplines;
iteratively integrate the input and the blueprint of the sub-solution to at least one of the plurality of sub-issues into a blueprint of the solution;
transmit the blueprint of the solution to the memory for storage; and
transmit the blueprint of the solution to the client.

35. The system of claim 34 wherein the processor is further operative with the program to:
modify the blueprint of the solution to the EHS management problem into a resalable EHS commodity;
transmit the EHS commodity and/or information thereof to the memory for storage;
make the EHS commodity and/or information thereof available to a plurality of potential EHS commodity buyers;
receive at least one purchase order from the plurality of potential EHS commodity buyers; and
transmit the EHS commodity to the plurality of potential EHS commodity buyers pursuant to a purchase agreement.

36. The system of claim 35 wherein the processor is further operative with the program to make the EHS commodity and/or information thereof available to a plurality of potential EHS commodity buyers via the Internet.

37. The system of claim 34 wherein the processor is further operative with the program to:
modify the blueprint of the solution to the EHS management problem into a resalable EHS commodity;
receive a plurality of EHS commodities and/or information thereof from a plurality of potential EHS commodity sellers;
transmit the EHS commodities and/or information thereof to the memory for storage;
make the EHS commodities and/or information thereof available to a plurality of potential EHS commodity buyers;
receive at least one purchase order from the plurality of potential EHS commodity buyers; and
transmit the EHS commodity to the plurality of potential EHS commodity buyers pursuant to a purchase agreement.

38. The system of claim 37 wherein the processor is further operative with the program to make the EHS commodity and/or information thereof available to a plurality of potential EHS commodity buyers via the Internet.
